(19) United States
(12) Patent Application Publication
(10) Pub. No.: US 2018/0141157 A1
(43) Pub. Date: May 24, 2018

(54) Baffled Optical Waveguide

(71) Applicant: Branson Ultrasonics Corporation, Danbury, CT (US)

(72) Inventors: Hugh T. MCNAIR, W. Henrietta, NY (US); Scott CALDWELL, New Milford, CT (US); Marian BLASKO, Piestany (SK)

(73) Assignee: Branson Ultrasonics Corporation, Danbury, CT (US)

(21) Appl. No.: 15/813,485

(22) Filed: Nov. 15, 2017

Related U.S. Application Data
(60) Provisional application No. 62/424,794, filed on Nov. 21, 2016.

(51) Int. Cl. B23K 26/21; G02B 27/09; B23K 26/064

(52) U.S. Cl. CPC B23K 26/21; B23K 26/064; G02B 27/0988; G02B 27/0994

(57) ABSTRACT

A baffled optical waveguide has a body shaped to partially or wholly surround a part or parts being processed by being illuminated with light. The body has optical baffles therein that define light channels through which the light travels as it transits the baffled optical waveguide. Outlets of the light channels are adjacent an opening in the body which receives an area or areas of the parts or parts being processed. Each light channel homogenizes the light as it transits through that light channel. The optical baffles that define the light channels keep light from diverging in the baffled optical waveguide as it transits through the light channels. In an aspect, a part (or parts) is processed by illuminating it with light via the baffled optical waveguide.

### CROSS-REFERENCE TO RELATED APPLICATIONS

This application claims the benefit of U.S. Provisional Application No. 62/424,794 filed Nov. 21, 2016. The entire disclosure of the above application is incorporated herein by reference.

### FIELD

The present disclosure relates to processing parts using light, and more particularly to a baffled optical waveguide.

### BACKGROUND

This section provides background information related to the present disclosure which is not necessarily prior art.

Light is used in processing a part or part, such as in laser welding or cutting. A typical radial optical waveguide 100 for laser welding of plastic is shown in FIGS. 1 and 2. The radial optical waveguide 100 has two spaced apart disks 102 having a central bore 104 in which parts 106, 108 to be welded are received. A space 110 between the disks is transmissive to laser light. The space 110 between the disks may for example be air, vacuum or a transmissive material sandwiched between the disks. The disks 102 may be made of a material having a lower index of refraction than the index of refraction of the space between the disks. The disks 102 may also be made of a reflective material or have reflective surfaces that face each other across the space 110 between the disks. Laser light sources 112 are spaced around an outer circumference 114 of the radial optical waveguide 100 and direct laser light into the space 110 between the disks. Only some of laser light sources 112 in FIG. 2 are shown identified by reference number 112 for clarity. The laser light is homogenized as it travels through the space 110 between the disks 102 and impinges upon the parts 106, 108 being welded upon exiting the space 110 between the disks 102 at an inner diameter 116 of the radial optical waveguide. Inner diameter 116 defines central bore 104. The laser light sources 112 may for example be fiber optics leading from an output of a laser or lasers. The laser light sources may for example each be a laser diode.

When the prior art radial optical waveguide 100 is used to direct laser light 300 (FIG. 3) to the parts 106, 108 to be welded, the laser light 300 diverges as it transits through the radial optical waveguide 100 and a large amount of the laser light misses the parts 106, 108 being welded as can be seen in FIG. 3. This is inefficient, and causes a large amount of laser light 300 to go to the other side of the radial optical waveguide 100, thus feeding back laser light to the laser light sources 112. For clarity, only some of laser light sources 112 are identified with reference number 112 in FIG. 3. Fed back laser light can cause self illumination damage to lasers, and for lasers with feedback sensing for intensity control, the fed back signal can falsely show too high a signal, resulting in the output of the lasers being lowered by their control.

### SUMMARY

This section provides a general summary of the disclosure, and is not a comprehensive disclosure of its full scope or all of its features.

In accordance with an aspect of the present disclosure, a baffled optical waveguide has a body shaped to partially or wholly surround a part or parts being processed by being illuminated with light. The body has optical baffles therein that define light channels through which the light travels as it transits the baffled optical waveguide. Outlets of the light channels are adjacent an opening in the body which receives an area or areas of the parts or parts being processed. Each light channel homogenizes the light as it transits through that light channel. The optical baffles that define the light channels keep light from diverging in the baffled optical waveguide as it transits through the light channels.

In an aspect, the light channels have a higher optical transmissivity than material of the disk shaped body that surrounds the light channels. In an aspect, the light channels are voids. In an aspect, the light channels are made of a material having a higher transmissivity than the material of the disk shaped body that surrounds the light channels.

In an aspect, the baffled optical waveguide is a baffled radial optical waveguide in which the body is a disk shaped body having a central opening that receives the area or areas of the part or parts being processed and the light channels prevent the light from missing the part or parts being processed and coming back into light sources on an opposite side of the baffled radial waveguide.

In an aspect, the light channels are monolithic.

In accordance with an aspect of the present disclosure, a method of processing at least one part by illuminating it with light includes disposing an area of the part to be illuminated by the light in an opening of a body of a baffled optical waveguide adjacent openings of light channels defined by optical baffles of the body. The method further includes directing the light into the light channels and homogenizing the light with the light channels as the light transits through the light channels. The method also includes preventing the light from diverging in the baffled optical waveguide with the optical baffles.

In an aspect, the body is a disk shaped body and disposing the area of the part to be illuminated by the light in the opening of the body of the baffled optical waveguide includes disposing the area in a central bore of the disk shaped body, the method further including preventing with the light channels the light from missing the area of the part.

In an aspect, processing the at least one part includes laser welding two parts together, disposing the area in the central bore of the disk shaped body includes disposing areas of the two parts that are to be laser welded together in the central bore of the disk shaped body, directing light into the light channels includes directing laser light into the light channels, and preventing with the light channels the light from missing the area of the part includes preventing with the light channels the laser light from missing the areas of the two parts being laser welded together and coming back into laser light sources on an opposite side of the baffled optical waveguide.

### DRAWINGS

The drawings described herein are for illustrative purposes only of selected embodiments and not all possible implementations, and are not intended to limit the scope of the present disclosure.

FIG. 1 is a perspective view of a prior art radial optical waveguide;

FIG. 2 is a perspective view of the prior art radial optical waveguide of FIG. 1 without the opposed spaced apart disks;

FIG. 3 is a diagrammatic view of direction of laser light by the prior art radial optical waveguide of FIG. 1;

FIG. 4 is a perspective view of a baffled optical waveguide in accordance with an aspect of the present disclosure;

FIG. 5 is a perspective view showing an arrangement of optical baffles in the baffled optical waveguide of FIG. 4 that define light channels having an annular cross-section; and

FIG. 6 is a perspective view of one the light channels of FIG. 5.

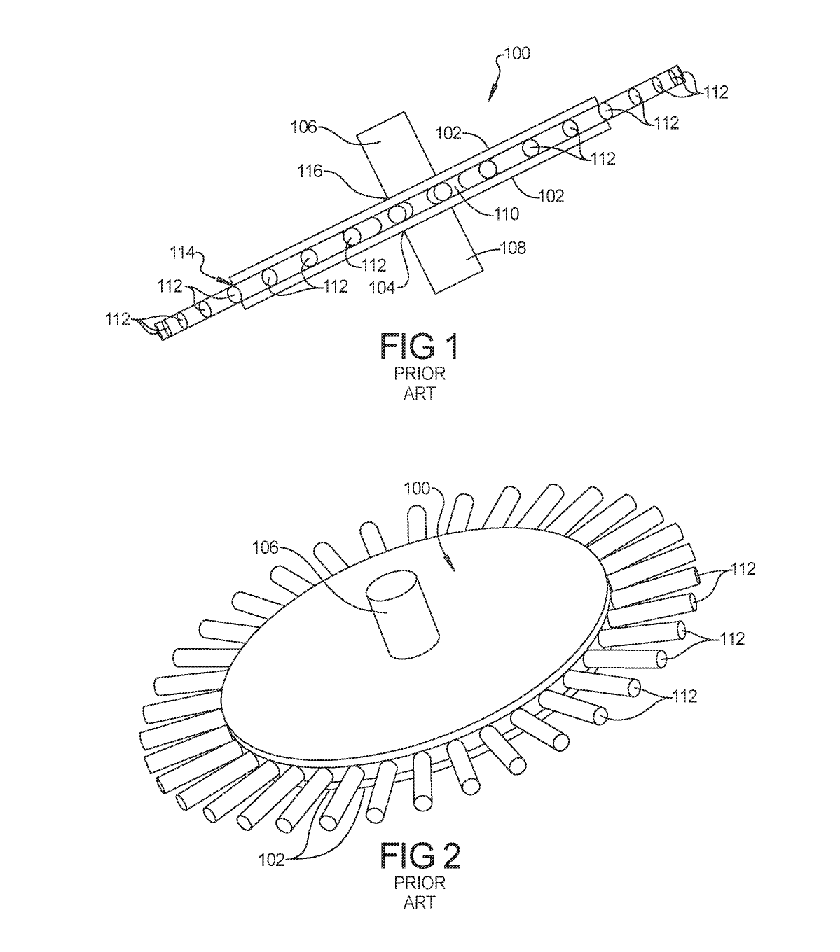

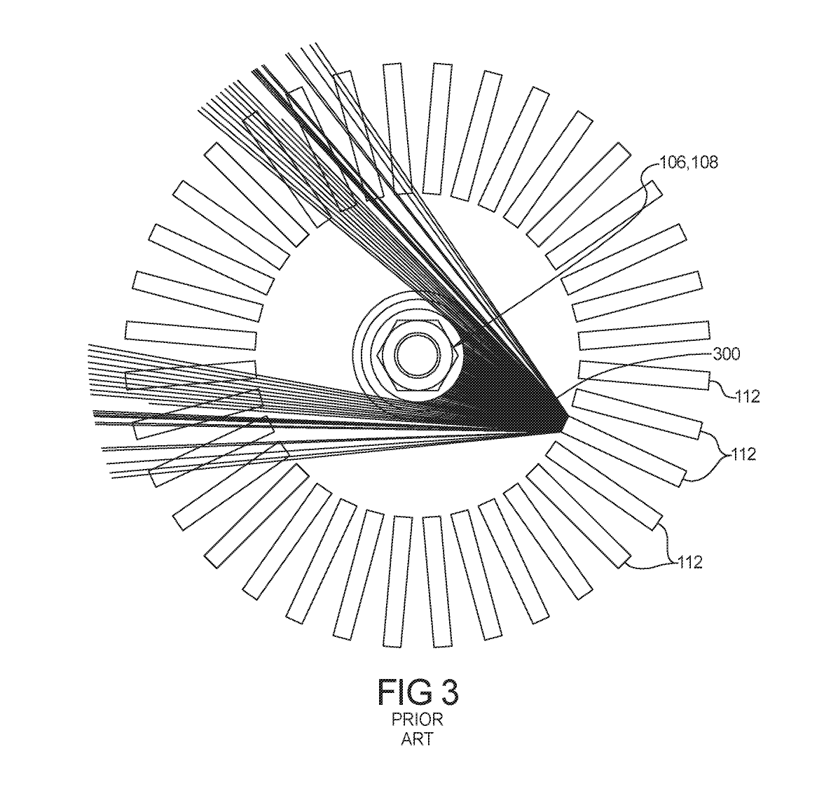

Corresponding reference numerals indicate corresponding parts throughout the several views of the drawings.

### DETAILED DESCRIPTION

Example embodiments will now be described more fully with reference to the accompanying drawings.

In an accordance with an aspect of the present disclosure, a baffled optical waveguide has a body shaped to surround (partially or wholly) a part or parts being processed by being illuminated by light, such as in laser welding or cutting. The baffled optical waveguide has optical baffles therein that define light channels through which the light being used for processing the part or parts travels as it transits through the baffled optical waveguide. Outlets of the light channels are adjacent an area or areas of the part or parts being processed when the part or parts are surrounded (partially or wholly) by the optical waveguide. The light that is used for processing the part or parts can be laser light or it can be broadband illumination. Since the light exits the light channels adjacent the part or parts being processed, this keeps the light from diverging from the part or parts and prevents the light from illuminating the opposite side of the baffled optical waveguide. The light channels are monolithic, whether by being a void or being made of a monolithic material. Further, outlets of the light channels are configured so that the light exiting each outlet is shaped to match the shape of an area of the part (or parts) being processed that the laser light impinges upon when it exits the outlet. Each light channel homogenizes the light as is transits through the light channel so that the light exiting the outlet of the light channel is homogenized.

In accordance with an aspect of the present disclosure, a part or parts is processed using laser or broadband illumination that is delivered through light channels in a baffled optical waveguide. The baffled optical waveguide homogenizes the light from the laser or broadband sources and the light channels prevent prevents the light from diverging in the waveguide. The light exits the light channels adjacent the part or parts being processed and this keeps light concentrated on the area of the part or parts being processed. As used herein, adjacent means close enough so that the light does not miss the part or parts being processed.

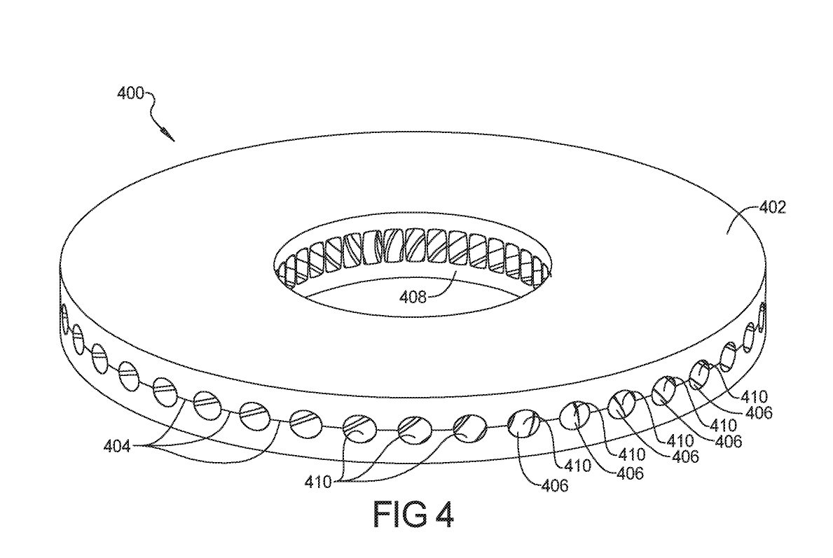

FIG. 4 shows an example of a baffled optical waveguide in accordance with an aspect of the present disclosure that is a baffled radial optical waveguide 400. The baffled radial optical waveguide 400 of FIG. 4 has a disk shaped body 402 having a plurality of optical baffles 404 therein that define light channels 406 and a central opening 408 in which the area of the part or parts to be processed is received. It should be understood that the light channels 406 have a higher optical transmissivity than the material of the disk shaped body 402 that surrounds the light channels 406 with the material of the disk shaped body 402 surrounding the light channels 406 comprising the optical baffles 404. For clarity, only some of the optical baffles and light channels are identified with reference numbers 404, 406, respectively, in FIG. 4. The light channels 406 can for example be voids or be made of a material having a higher transmissivity than the material of the disk shaped body 402 surrounding the light channels 406. Alternatively or additionally, walls of the light channels 406 can have reflective surfaces with the walls of the light channels comprising the optical baffles.

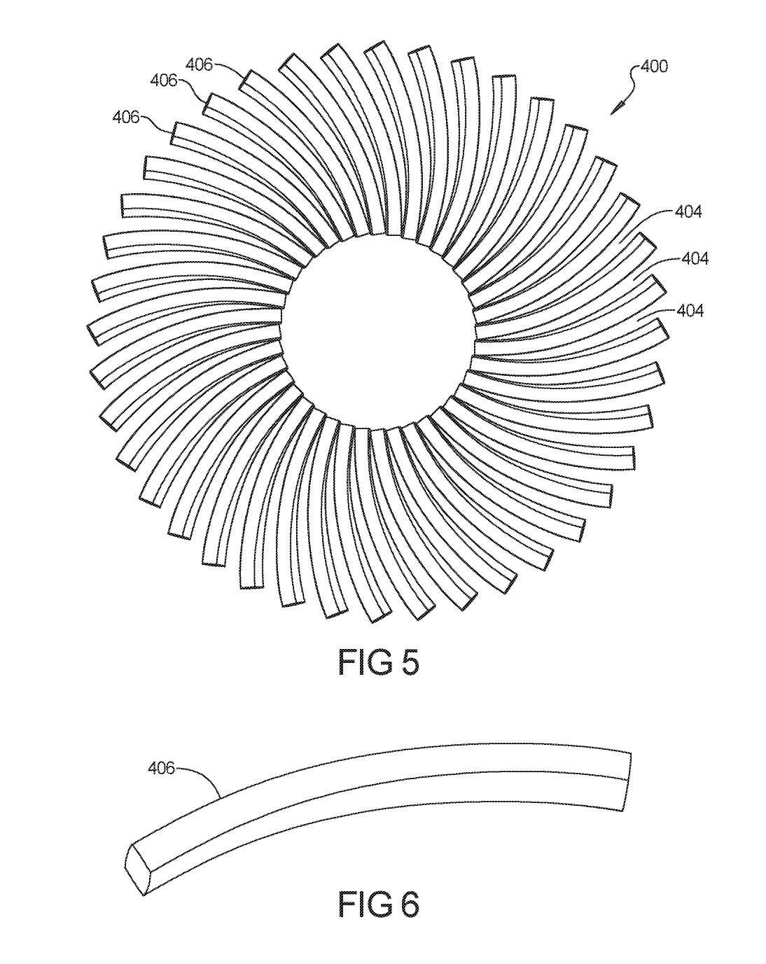

FIG. 5 shows an example of an arrangement of optical baffles 404 in the baffled radial optical waveguide 400 of FIG. 4 that define light channels 406 having an annular cross-section. FIG. 6 shows one of the light channels 406 of FIG. 5. The light in the baffled optical waveguide 400 is prevented from diverging in the baffled optical waveguide by the optical baffles 404 that define the light channels 406. This keeps light concentrated on the area on the part or parts to be processed.

In the case of radial processing such as a baffled radial optical waveguide 400 that surrounds the part or parts being processed, the light channels 406 defined by the optical baffles 404 also keep the light from missing the part or parts being processed and coming back into laser or broadband sources on the other side of the baffled radial waveguide.

In all cases, including curved and linear baffled optical waveguides, the optical baffles 404 that define the light channels 406 keep reflected light from entering adjacent optical sources. In both cases, preventing return of light back to the source prevents optical laser damage if a laser is used, and prevents false feedback signals for closed loop control for both laser and broadband sources.

The optical baffles 404 in the baffled optical waveguide 400 can separate the light from individual sources, or can separate the light from multiple sources.

The optical baffles 404 can be oriented radially around a part or parts being processed, or perpendicular to the surface of the part or parts being processed, or oriented in any direction that would direct the light energy towards the part or parts being processed while still separating various laser or broadband light sources.

The baffled optical waveguide can be either a positive or negative waveguide. A positive waveguide is made of a transmissive material where the light channels are made of or comprise a material having a higher index of refraction than the transmissive material to allow for total internal refection in the light channels. A negative waveguide is made of a reflective material so that surfaces surrounding the light channels are reflective surfaces with these surfaces comprising the optical baffles. A positive waveguide can also be made of a transmissive material where the surfaces of the waveguide surrounding the light channels are reflective surfaces with these reflective surfaces comprising the optical baffles. For example in the two immediately preceding cases, the walls of the channels have reflective surfaces.

With reference to the baffled radial optical waveguide of FIG. 4, in an aspect, the light channels 406 are voids in the material of the disk shaped body 402 and the optical baffles 404 are the material of the disk shaped body 402 that surrounds the voids. In an aspect, surfaces of the material of the disk shaped body 402 surrounding the voids are reflective surfaces. In an aspect, the light channels 406 are made of transmissive material and the disk shaped body 402 made of material having a lower index of refraction than the transmissive material of the light channels 406 and the material of the disk shaped body 402 surrounding the light channels providing the optical baffles 404. In an aspect, walls 410 (only some of which are identified with reference number 410 in FIG. 4) of the light channels 406 have reflective surfaces with the walls 410 comprising the optical baffles 404.

The optical baffles 404 can be parallel to each other, but could also could also diverge, converge, or be curvilinear. The light channels 406 defined by the optical baffles 404 thus could have parallel sides, but could also diverge, converge, or be curvilinear.

Any sort of optics can be used between the laser or broadband sources and the baffled optical waveguide 400, such as lenses, prisms, other waveguides, optical fibers, etc.

The part or parts to be processed could be made of any material such as plastic, metal, stone, food, skin, etc. The process can be any process that needs laser or broadband light, such as welding, cutting, curing, stripping, cooking, burning, bleaching, etc.

The light source or sources can be any combination of lasers and/or broadband sources.

In an aspect, the baffled optical waveguide 400 is used in a laser system to weld plastic where laser light is delivered through fiber optics to the baffled optical waveguide 400 and transits through the baffled optical waveguide to the plastic being welded.

There are advantages to a baffled optical waveguide, that is, having optical baffles 404 in an optical waveguide. One is that no light misses the part or parts being processed. A second is that the light is directed to the desired area of the part or parts being processed. A third is that light is prevented from passing across the baffled optical waveguide to the sources of light on the other side of the baffled optical waveguide. A fourth is that the light is prevented from bouncing off the part or parts being processed from one light source to another. With regard to the third and fourth advantages, preventing feedback light from one light source into other light sources prevents false readings for systems with optical feedback control, and for systems that use laser, prevents potential laser self-illumination damage.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A baffled optical waveguide, comprising:
a body shaped to partially or wholly surround a part or parts being processed by being illuminated with light;
the body having optical baffles therein that define light channels through which the light travels as it transits the baffled optical waveguide;
outlets of the light channels are adjacent an opening in the body which receives an area or areas of the parts or parts being processed;
each light channel homogenizing the light as it transits through that light channel; and
the optical baffles that define the light channels keep light from diverging in the baffled optical waveguide as it transits through the light channels.

2. The baffled optical waveguide of claim 1 wherein the light channels have a higher optical transmissivity than material of the disk shaped body that surrounds the light channels.

3. The baffled optical waveguide of claim 2 wherein the light channels are voids.

4. The baffled optical waveguide of claim 2 wherein the light channels are made of a material having a higher transmissivity than the material of the disk shaped body that surrounds the light channels.

5. The baffled optical waveguide of claim 1 wherein the baffled optical waveguide is a baffled radial optical waveguide in which the body is a disk shaped body having a central opening that receives the area or areas of the part or parts being processed and the light channels prevent the light from missing the part or parts being processed and coming back into light sources on an opposite side of the baffled radial waveguide.

6. The baffled optical waveguide of claim 1 wherein the light channels are monolithic.

7. A method of processing at least one part by illuminating it with light, comprising:
disposing an area of the part to be illuminated by the light in an opening of a body of a baffled optical waveguide adjacent openings of light channels defined by optical baffles of the body;
directing the light into the light channels and homogenizing the light with the light channels as the light transits through the light channels; and
preventing the light from diverging in the baffled optical waveguide with the optical baffles.

8. The method of claim 7 wherein the body is a disk shaped body and disposing the area of the part to be illuminated by the light in the opening of the body of the baffled optical waveguide includes disposing the area in a central bore of the disk shaped body, the method further including preventing with the light channels the light from missing the area of the part.

9. The method of claim 8 wherein processing the at least one part includes laser welding two parts together, disposing the area in the central bore of the disk shaped body includes disposing areas of the two parts that are to be laser welded together in the central bore of the disk shaped body, directing light into the light channels includes directing laser light into the light channels, and preventing with the light channels the light from missing the area of the part includes preventing with the light channels the laser light from missing the areas of the two parts being laser welded together and coming back into laser light sources on an opposite side of the baffled optical waveguide.
